(19) United States
(12) Patent Application Publication
(10) Pub. No.: US 2011/0162299 A1
(43) Pub. Date: Jul. 7, 2011

(54) MODULAR UNIT FOR CREATING LOAD-BEARING STRUCTURES, FOR USE AS A CONSTRUCTION AND/OR SUPPORT FOR A SOLAR CARPET

(75) Inventor: Claudio Azzolini, Parma (IT)

(73) Assignee: ATMA ENGINEERING S.N.C. DI AZZOLINI SILVANA, Parma (IT)

(21) Appl. No.: 12/994,311

(22) PCT Filed: May 22, 2009
(86) PCT No.: PCT/IB09/52158

§ 371 Date: Nov. 23, 2010

(30) Foreign Application Priority Data
May 23, 2008 (IT) PR2008A000035

(51) Int. Cl. E04H 14/00; B29C 47/00; B32B 37/14; B32B 37/02

(52) U.S. Cl. 52/173.3; 156/244.11

(57) ABSTRACT

A modular unit (1) of customizable color for creating load-bearing structures, photovoltaic houses, for use as a construction and/or a support for photovoltaic carpets (7). Namely, this support or modular base unit, made of extruded plastic, can act as a floor, roof, and/or lateral panel/support; furthermore, this module may be also used as a support for a photovoltaic carpet mounted thereto; thus, the photovoltaic carpet can be mounted to a plastic support instead of the usual metal support or bitumen sheets, as is typically used. This allows one-time application of the photovoltaic carpet (7), even without a thermoplastic load-bearing or containing support, by simply laying it to existing rigid surfaces over the desired areas (B8), and ensuring chemical bonding at the lateral ends, with water tightness guaranteed over time.

The present invention relates to a modular unit for creating load-bearing structures, for use as a construction and/or a support for photovoltaic sheets. In practice, this may provide a full modular photovoltaic house.

Namely, this support or modular base unit, made of extruded plastic, can act as a floor and/or lateral panel/support; furthermore, this module may be also used as a support for a photovoltaic carpet mounted thereto; thus, the carpet would be mounted to a plastic support instead of the usual metal support or the bitumen sheets, as is typically used.

The invention also relates to the load-bearing structure obtained from various assembled modular units, which units may act, according to their size and length, as side walls (perimeter and interior walls), as a floor and/or roof; this load-bearing structure so formed also includes a support platform whose base is designed to receive the lateral modular units (1) by interlock means, to vertically support them.

The advantages provided by the present invention and the use of the present unit/support may be summarized as follows:

1. It is a continuously extruded load-bearing floor, which may fully replace a traditional beam and block floor or a polystyrene floor,

2. It may be used as a lateral infill panel and/or as a support panel,

3. It provides high thermal insulation, due to the provision of appropriate air gaps,

4. It provides high sound insulation,

5. The possibility of using a photovoltaic carpet avoids the need for skilled labor, thereby reducing costs.

As mentioned above, there are currently provided in the art multilayer photovoltaic carpets joined together by metal covers, as well as photovoltaic systems applied to bitumen sheets; nevertheless, both solutions only act as water barriers and as photovoltaic systems.

The combined system of a photovoltaic carpet and plastic support, which is also covered by the invention, has multiple purposes, in that it is used for water retention, as a load-bearing floor, for heat and sound insulation, as a rain water container, or as a lateral infill and/or load-bearing wall panel.

In addition, the photovoltaic carpet disclosed herein has multiple layers and particularly the top layer (i.e. the one in direct contact with light) has a slip-self-cleaning purpose, i.e. it is of help in keeping the surface clean by simply using rain drops, due to its low friction; also, it can be walked on and is hail-resistant.

The remaining layers include, from top to bottom:
a transparent electrode
various layers of light-absorbing photovoltaic cells, of different colors depending on the characteristics required thereof
at least one reflecting area
a watertight and weather-resistant plastic base sheet (which is only used if no load-bearing base is provided); such sheet having at least one adhesive strip for ensuring a junction and seal function by being laid over the adjacent ones, after being placed onto the existing load-bearing base.

As mentioned above, the support is adapted to be coupled to additional supports; therefore, the invention also relates to the construction comprising the plurality of said supports/modular units coupled and joined together. The modular unit support, which is extruded may be of such a size as to act as a lateral wall, a floor, a roof, etc.

These objects and advantages are achieved by the modular unit for creating load-bearing structures, for use as a construction and/or a support for photovoltaic sheets according to this invention, which is characterized as set out in the annexed claims.

This and other features will be more apparent from the following description of a few embodiments, which are shown by way of example and without limitation in the accompanying drawings, in which:

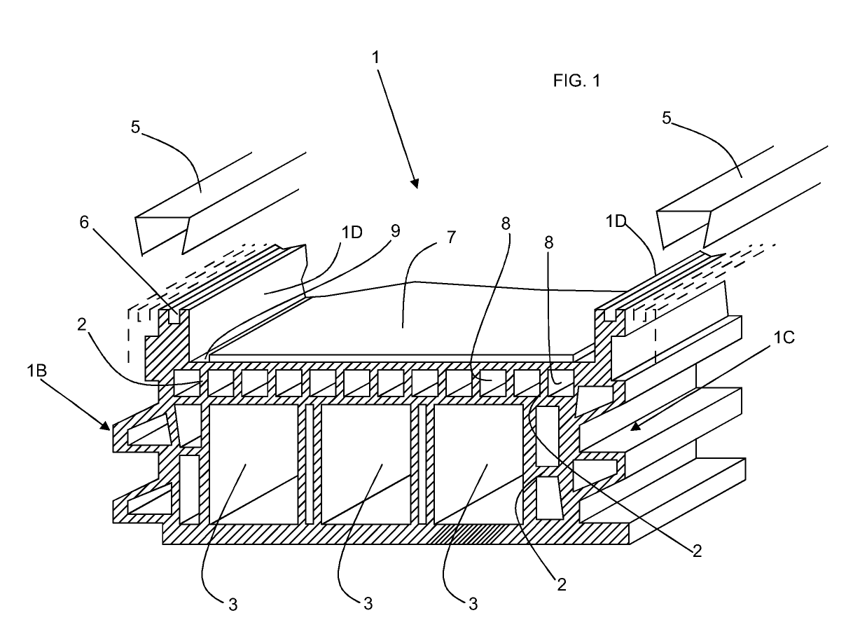

FIG. 1 is a perspective view of a modular unit for creating load-bearing structures, for use as a construction and/or a support for photovoltaic carpets, according to the present invention,

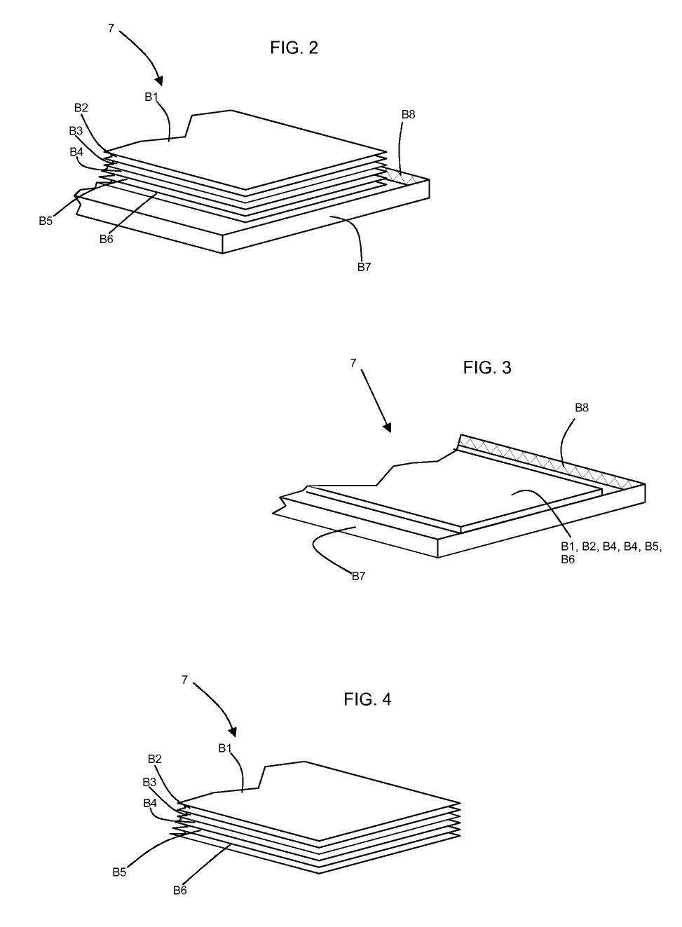

FIG. 2 is an exploded view of a multilayer photovoltaic carpet having an adhesive sheet, through all the layers,

FIG. 3 shows a multilayer photovoltaic carpet having an adhesive sheet,

FIG. 4 is an exploded view of a multilayer photovoltaic carpet laid over the unit as shown in FIG. 1, through all the layers.

Referring now to FIG. 1, numeral 1 generally designates a modular/support structure made of thermoplastic materials of either reinforced, filled, chemically bonded type or not, which is used as a support/floor and/or a lateral panel/support, for constructions, as needed.

The support 1 is generally a shell obtained by continuous extrusion, which may be also formed of different plastic materials according to its position, geometry, etc. . . . . For instance, the plastic material for exterior use may be different from that for interior use, thereby providing a sort of multilayer plastic panel.

The sizes and heights of the support 1 may be variable, so that it may fully replace a traditional beam and block floor, a polystyrene floor or a wood floor.

The ends 1B, 1C of said support 1 have a shape that allows interlocking with the corresponding ends 1B, 1C of additional modular units 1.

Two interlocked modules 1 may possibly be further attached together by special connecting profiles 5, adapted to join together two adjacent and projecting edges 1D. A passageway 6 is provided within the edge 1D, for holding cables and/or wires or else, for easier customization.

Nevertheless, in a more general embodiment, the various units 1 may be also joined together by lateral end profiles, designated by 1B and 1C.

A number of ribs 2 are internally arranged to allow some self-supporting ability of the unit 1.

These ribs 2 are also provided in a given number under the surface 9, in a manner that they define ventilation or water passages 8. This function provides advantages when a multilayer photovoltaic carpet 7 (as described below) is laid upon said surface for easier cooling and heating of the photovoltaic system and this improve its performance.

Also, the set of ribs 2 creates one or more cavities in the unit 1, having a dual purpose:

1. containing/recovering rain water, when the unit 1 is used as a lateral panel,

2. containing electric wires or hydraulic pipes

3. receiving beams, preferably made of metal, for increasing the ability of supporting snow loads (according to their thickness and number)

4. providing an interlock for assembly, as described above.

In one variant embodiment, not show, the plastic shell includes reinforcements of a stronger material.

Such stronger material is of metal type. Such stronger material is of iron type. Said reinforcement material is inserted into said shell during extrusion thereof, or directly during installation.

The unit 1 may be combined with a photovoltaic carpet 7, as shown in detail in FIG. 4, which is attached to its surface designated by numeral 9 in FIG. 1, therefore the photovoltaic carpet is mounted to a plastic support instead of the usual metal support or the bitumen sheets, as is typically used.

Particularly referring to FIGS. 2, 3 and 4, the multilayer photovoltaic carpet 7, see FIG. 4, is formed by continuous extrusion without length limits, or has a size defined by molding and subsequent coupling.

The top layer B1 (i.e. the one in direct contact with light) is a paint or a film/sheet having a slip and/or self-cleaning purpose, i.e. it is of help in keeping the surface clean by simply using rain drops, due to its low slip friction.

One more peculiar feature of the carpet 7 is the provision of a watertight and weather-resistant thermoplastic base sheet B7; such sheet having at least one adhesive strip B8 for ensuring a junction and seal function by being laid over the adjacent ones; such sheet is not required if the photovoltaic system is directly coupled to the thermoplastic support 1 that is used as a cover, load-bearing cover, or lateral panel.

The remaining layers include, from top to bottom:
a transparent electrode B2
various layers B3, B4, B5 of light-absorbing photovoltaic cells, of different colors depending on the characteristics required thereof
at least one reflecting area B6.

The interlocking self-supporting plastic modular unit 1, is interlockingly modular with no thermo-acoustic bridge, and allows subsequent application of the photovoltaic carpet by chemical bonding.

The present invention also includes the photovoltaic carpet 7 as a one-time application, without a thermoplastic load-bearing or containing support, by simple application thereof onto existing rigid surfaces over the desired areas B8, and chemical bonding at the lateral ends, with watertightness guaranteed over time.

It shall be noted that a free volume is defined under the photovoltaic carpet 7, when the latter is integrated with the module 1, which volume may be filled with air or another fluid acting as a temperature control for the overlaying module; this will ensure operation of the photovoltaic system during the winter, with any ice or snow present thereon being thawed out; also, the carpet 7 will be cooled during the summer, with cold fluid being used for heat exchange.

The modules, i.e. the modular units 1, have cavities pre-formed therein (by appropriate shaping) during the extrusion process, which may act as passageways for electric wires, drains, hot/cold air, etc.

For improved watertightness between adjacent modules, one or more sheets of extruded rubber may be introduced into corresponding cavities formed at mutual contact sides.

The invention further relates to a load-bearing structure comprising a number of modular units 1 which operate, according to their size, as:
exterior walls,
interior walls,
floor,
roof.

The modular units 1 may be assembled together and supported by means as described above and, concerning the load-bearing structure, they are vertically supported by a support platform whose base is designed to receive the lateral modular units 1 by interlock means. Since the modular units have the photovoltaic carpet integrated therewith, they will be able to provide the energy required for proper operation of the structure so formed.

In practice, a number of modular units shall have to be assembled to form the lateral wall of the house unit; the same shall apply for the floor and the roof; the whole assembly shall have the same base/platform for supporting and interlocking the lateral modular units.

The interlocking parts may be blocks extending from said base and having mating shapes, with similar slots/cavities, as shown by numerals 2 and 3. These cavities may be identical to those of the unit 1 that acts as a lateral panel, otherwise said slots/cavities will be intermediate elements between the base and the unit 1, and have projections and slots, mating with those of the base and the unit 1.

Concerning the modular units 1 that are designed to act as a load-bearing floor, once again the end parts 1B, 1C (and possibly the portion 1D as described above) will be used for mutual interlocking; connection with the vertical modular units (acting as lateral retention walls) shall occur by using additional intermediate support components between said unit/floor and said unit/side wall, whose shape may include projections and/or slots mating with corresponding ones of the unit/floor and lateral unit/wall.

The above construction system formed with the modular units is a self-supporting plastic construction system; upon installation of the photovoltaic cover, the latter will turn photovoltaic energy into the electric energy required for the structure to be self-powered on each occasion.

In addition, the system is wholly recyclable, due to its being composed of plastic modular units.

1.-15. (canceled)

16. A modular unit (1) for creating load-bearing structures for use as a construction, said modular unit comprising a plastic shell designed to act as a support or floor or roof and/or lateral panel/support for constructions; said shell having parts (1B, 1C) with shapes allowing them to be interlocked with corresponding parts (1B, 1C) of other modular units (1), to act as or replace a traditional beam and block or polystyrene floor; while eliminating any thermal bridge, said shell comprises a number of inner ribs (2) arranged to impart some self-supporting ability to the unit (1) and formed under the surface (9) to create ventilation or water passages (8), characterized in that said plastic shell incorporates, in at least one of its surfaces, a multilayer photovoltaic carpet (7) comprising
a top layer (B1), i.e. the one in direct contact with light, having a slip-self-cleaning purpose, allowing to keep the surface clean by simply using rain drops, due to its low friction
a transparent electrode (B2)
various layers (B3, B4, B5) of light-absorbing photovoltaic cells, of different colors depending on the characteristics required thereof
at least one reflecting area (B6).

17. A method for obtaining a modular unit (1) as claimed in claim 16 characterized in that it comprises the step of continuous extrusion of one or more plastic materials; said photovoltaic carpet (7) is fixed to the unit (1) during simultaneous production, and provides a single module, assembled during extrusion by both thermal and chemical bonding.

18. A load-bearing structure, characterized in that it comprises multiple modular units (1) as claimed in claim 16.

19. A load-bearing structure as claimed in claim 18, characterized in that said modular units (1) are vertically supported by a support platform whose base is designed to receive the lateral modular units (1) by interlock means.

20. A modular unit (1) as claimed in claim 16, characterized in that said ribs (2) create one or more cavities (3) inside the unit (1) for containing/recovering rain water if the unit 1 is used as a lateral panel.

21. A modular unit (1) as claimed in claim 16, characterized in that said ribs (2) create one or more cavities (3) inside the unit (1) for holding beams and/or electric wires and hydraulic pipes; the cavities being also usable for interlocking the modules.

24. A modular unit (1) as claimed in claim 16, characterized in that two interlocked modules (1) may be further held and fixed together by special connecting profiles (5), which are designed to join two adjacent projecting edges (1D), to prevent any ingress of water and protect cables.
